(19) United States
(12) Patent Application Publication
(10) Pub. No.: US 2009/0133108 A1
(43) Pub. Date: May 21, 2009

(54) SYSTEMS FOR SECURE AUTHENTICATION FOR NETWORK ACCESS

(76) Inventor: David Barwin, Golden, CO (US)

Correspondence Address: GLENN L. WEBB;GLENN L. WEBB P.C., P.O BOX 951, CONIFER, CO, 80433, US

(21) Appl. No.: 11/306,440

(22) Filed: Dec. 28, 2005

Related U.S. Application Data
(60) Provisional application No. 60/595,371, filed on Jun. 27, 2005.

(51) Int. Cl. H04L 9/32; G06F 21/00

(52) U.S. Cl. 726/7

(57) ABSTRACT

Systems and methods for authenticating the identity of a user over a network. The user must supply a removable physical medium such as CD, DVD, or memory stick that contains security information about the user and the user's account as well as a user identification and password. This information is verified before the user is allowed to access the account.

### FIELD OF THE INVENTION

This invention relates to the field of providing secure access to accounts across network communications.

### BACKGROUND OF THE INVENTION

The transmission of information over the internet and other networks has increasingly become a critical issue. Unfortunately it is becoming more and more commonplace for such information to be hacked or otherwise improperly retrieved. Such hacking may be in terms of a physical intrusion and retrieval of stored information, interception of such information, phishing (social engineering or trickery to receive information) or other techniques. Once this information is improperly received, then it is often put to improper uses such as identity theft, fraud, vandalism and other detrimental acts. Financial accounts are often accessed in this manner. Often, the perpetrator will take over a financial account and change the account information, user identification and passwords to prevent the original account holder from even accessing information regarding their own account. Other accounts may be taken over in a similar manner and used for inappropriate purposes.

A typical authentication process for access across a network, such as the Internet, requires a user to log on with a user identification on the client side along with a password. This information can be improperly retrieved by theft of the server database information, by hacking, by phishing or by other means. This is becoming increasing more common. Thus, in network systems where secured transactions are critical, the need for a robust secured transaction system is critical.

There have been previous attempts at providing a robust secured transaction system. These systems use proprietary software that must be installed prior to use and are not particularly user friendly.

Other secured authentication systems require the use of smart cards or biometrics. These type of secured authentication systems require the installation of special hardware to read the smart cards or biometrics.

A need exists for a robust secure authentication system that can operate on most computer systems without the need for the installation of proprietary software or hardware to operate.

### SUMMARY OF THE INVENTION

The present invention solves these and other problems by providing systems and methods for authenticating the identity of a user over a network. These systems and methods provide a virtual hack proof way to verify the identity of a user before the user is able to gain access to an account or other information. This invention has applicability in financial institutions, for online voting systems, in digital media rights management, medical records, insurance information, background files, and any other area where the security of information is critical.

The present invention in a preferred embodiment requires the user to have possession of a physical media that contains security information about the user and the user's account. This physical media may be in the form of a CD, DVD, memory stick, floppy disc or any other type of removable storage media. This physical medium is provided by the account provider to the user during the account registration process. The security information may be an alphanumeric string, an algorithm, encrypted information or any other useful information. It may also include an auto-run feature that sends the user to the account verification portal once it is inserted in the user's computer.

The user enters the account verification portal and inputs their user identification and password. Then the security information is retrieved from the physical media. This eliminates the ability for unauthorized access of the account by merely hacking or phishing the user identification and password. The actual physical media must be present as well. Once the security information, the user identification and password are all verified, the user is allowed access to the account.

In another preferred embodiment, the system also uses a secure server that contains additional information about the user. This information is supplied by the account provider during the registration process. The system further verifies the identity of the user by this additional information. The user may also be queried interactively at that time as well for additional security information.

The system of a preferred embodiment also provides an audit trail. This audit trail may provide reports on the authentication process, unsuccessful authentication attempts, transactions that may have occurred, information that was accessed, files that may have been downloaded, ip addresses of the users, and any other information that may be useful.

The system and methods of one preferred embodiment also verifies the status of the user. This is useful where there may be various levels of access available according to the status of the user. Also, the system may verify any user credits or debits toward payments or other accounts. In one embodiment, the user is able to select downloadable licensed files. The system verifies that the licenses for these files are valid and current, and require the user to execute a license agreement for those files prior to downloading. This is particularly useful for images, video and music digital files.

These and other features are evident from the ensuing detailed descriptions of preferred embodiments and from the drawings.

### BRIEF DESCRIPTION OF THE DRAWINGS

FIG. 1 is a schematic of the authentication process of a preferred embodiment of the present invention.

FIG. 2 is a schematic of an alternative embodiment of the present invention.

FIG. 3 is a schematic of another alternative embodiment of the present invention.

### DETAILED DESCRIPTION OF PREFERRED EMBODIMENTS

The present invention provides a robust secure authentication system that minimizes the possibility of unauthorized access to secured information. This system includes applicability for financial transactions, for medical records, for digital rights management and for any purposes on a network where security is requisite. A preferred embodiment of this system is described herein for explanatory purposes. It is to be expressly understood that this exemplary embodiment is provided for descriptive purposes only and is not meant to unduly limit the scope of the present inventive concept. Other embodiments and uses of the present invention are included in the claimed inventions. It is to be expressly understood that other devices are contemplated for use with the present invention as well.

A preferred embodiment of the present invention provides systems and methods for preventing such unauthorized access to a secured account, such as in financial or other institutions. For example, it is becoming common for users to need to access their accounts at their bank or other financial institutions. The user and the institution cooperate to set up an account online to allow the user to freely access their information on their account. Typically during the setup of an account over the internet, the user provides personal and/or business information to the host. The user is then assigned an account with user identification and a password. The user can then access the account and make changes to their account such as the user identification and password.

Unfortunately, this type of information can be improperly retrieved in many instances through many types of methods. Once someone has the user identification and password, it is relatively easy to then access that account and make changes to the account including the user identification and password. Also, the account can then be used for purposes other than that intended by the account holder.

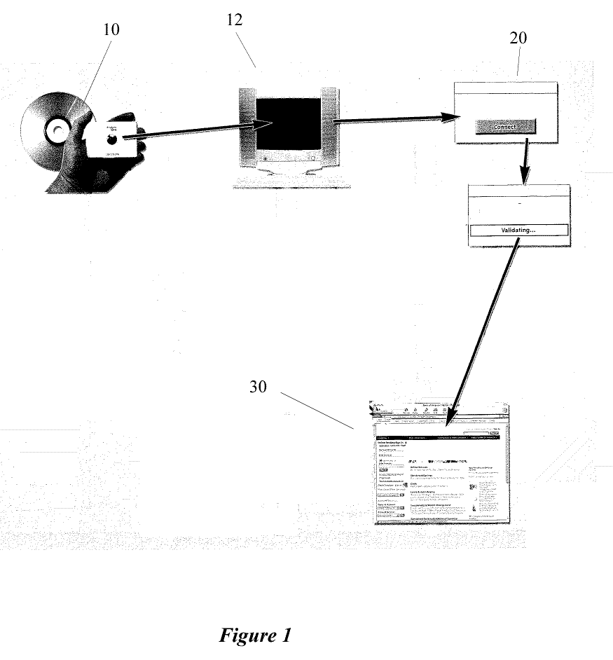

The system of a preferred embodiment of the present invention as shown in FIG. 1 provides a physical media that includes secure information regarding a user's account. The account may not be accessed or changed in any form without the use of the physical media. This prevents the unauthorized access or alteration to a user's account. The physical media may be a CD, floppy disk, DVD, memory stick or any other form of physical media. In this preferred embodiment, the physical media includes an alphanumeric sequence of sufficient length to minimize or prevent the accidental or intentional replication of the sequence. Additional information regarding the user's account may be included as well. The information may be encrypted as well to further minimize this information from being improperly accessed or utilized.

In one preferred embodiment, the system and method requires the user to request the physical media from the host during their account setup. The host then sends the physical media to the user who then uses that media to enable them to access their account. The account can not be accessed without the physical media being present. The host will request verification of this by requiring certain information to be transmitted from that disk. If additional security is required, the host can utilize an algorithm that will require or utilize different information from the media or change the way that information is utilized each time the account is accessed. For example, the media may include a sequence of random alphanumeric characters that is sequentially selected each time the account is accessed. Other algorithms may be used as well as encryption or other schemes. Preferably, the information is protected in some manner from being copied onto other media.

The user also is able to select their user identification and password during the set-up process. This may be done prior to receiving the physical media or after receiving the physical media. The user identification and password may also be assigned to the user.

Another preferred embodiment of the present invention requires the user to request the physical media prior to being able to set-up their account. Once they receive their physical media, the account may then be set-up using the information on the media.

The system and method of this embodiment as shown in FIG. 1 requires the user to insert their physical media 10 in their computer 12. An auto-run feature may be included to send the user to an account verification portal 20 on the network. The user inputs their user identification and password on this portal. The security information is retrieved from the physical media 10. The user identification, password and security information is verified against the provider's information. Once this information is verified, then the user is allowed access to the account 30.

Another preferred embodiment of the present invention allows access to the account without the media. If any account information is to be changed however the media must be present. This prevents the account from being hijacked or otherwise altered. It is not as secure as the other embodiments, as the account information may be viewed by unauthorized users having access to the user identification and password.

Another preferred embodiment of the present invention provides a long sequence of alphanumeric characters that are pushed out at high speed to prevent unauthorized interception of the password or account information. Also, the data may be encrypted to prevent or at least minimize such unauthorized use of the information.

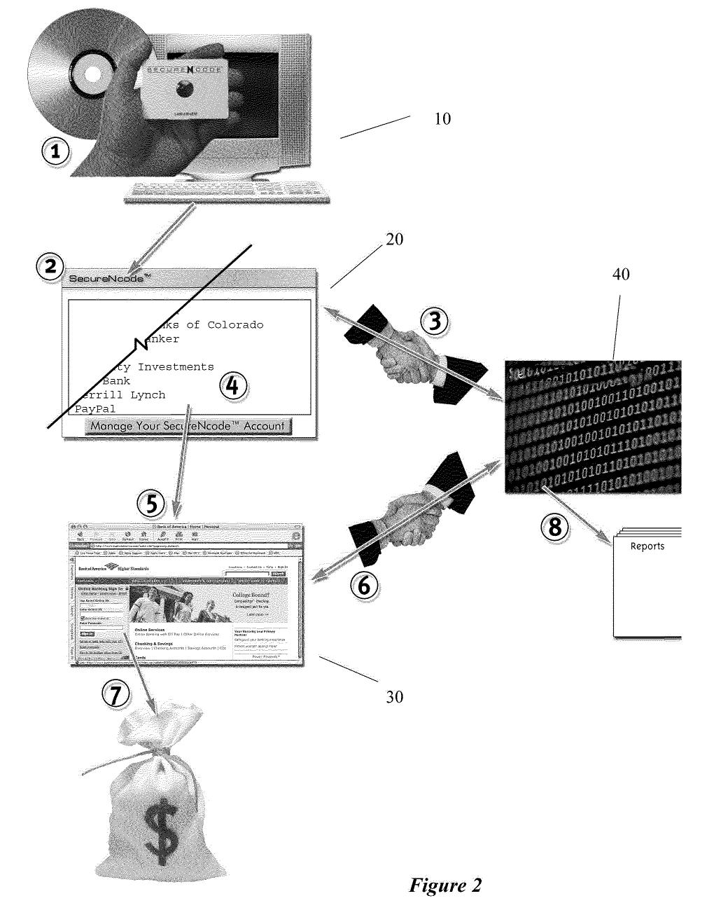

The system of a preferred embodiment adds another layer of security to the above described embodiments. The system, as shown in FIG. 2, includes a database 40 that also authenticates the user before access is granted. The information from the user is directed to this database. The database then verifies that the user identification, the user password and the authentication information from the physical media is cross-referenced with the database information. The database can also verify that the user is in good standing. The status of the user can also be set, such as the level of information that the user may receive. The database may also act interactively by querying the user for other security information. Once the user has been verified at this level, the user is then granted access to their account.

In another implementation of this preferred embodiment, database 40 first verifies that the removable media is in good standing. The database verifies the unique identification on the removable media and then verifies that this media has not been reported stolen or in some way compromised. It then verifies the user identification from the physical media and authenticates that information. The user password is verified from the client website. This information is maintained separately from the database 40 to provide additional security. Once the password has been verified along with the database information, the user is granted access to the account information.

Thus there are three keys that must be verified before authentication is granted. The first key is the user logon of their identification and password. The second key is the authentication information on the physical media. The third key is contained on the database. Since these keys are separately provided, it is extremely difficult for an unauthorized intruder to retrieve all three keys.

One example of the use of this system is for secured financial transactions. The financial institution provides the user with the physical media, such as a business card CD, mini CD, CD, DVD, memory card, memory stick, having the authentication information registered to that user. The user may be required to provide the registration information physically in person to the institution to ensure the identification of the user. Alternatively, the user is provided the physical media which directs the user to a registration website to input the information. Certain elements of the registration information is inputted into the database, preferably by the financial information. This information may set the status of the user as to what information they may access.

Once the account has been setup for that user, then the user may proceed with the authentication process. The user, in one preferred embodiment, inserts the physical media in their computer system. The physical media automatically directs the user to a designated website. This website may be that of the financial institution or it may be an intermediate website. The user is directed to logon with their identification and password. The authentication information is retrieved from the physical media either before the logon or after the logon. Both of these keys are then directed to the system which verifies both keys with additional information contained in the database. This acts as a third key for authentication purposes.

Once all three keys have been verified, then the user is directed to their account. The status of the user may also be set at that time as well. The status may limit the access of the user to certain information. Another important feature that the system may provide is an audit trail. The system can provide a report detailing the number of times that a particular user has accessed their account. These reports may also include details on the information that was accessed. Also, the reports may provide information as to the number of attempts to access the accounts, the addresses from which the access was attempted, and other security information. The system may also report the number of times that files have been downloaded.

This robust authentication system has applicability to many different environments. One such environment as discussed above is for use in financial institutes such as banks and credit card accounts. The system as described above provides a robust authentication process to ensure that only an authorized user may gain access to their financial account over the Internet. The requirement of secure information on a physical media along with user supplied information prevents unauthorized hacking of the account. A third security key provided on a secure server adds another layer of security.

The present invention in a preferred embodiment has applicability for use in online voting systems. The voter is provided with a voting card or certificate in the form of a secured compact disc, DVD or other removable storage media. This voting card includes information identifying the voter. The voter then logs into a secure voting website, or is directed there by the auto-run feature on the removable storage media. The voter provides their personal identification, such as social security number, vote registration number, or other personal identification and password. This information is matched with the identifying information from the removable media. The voter may then be allowed access to their voting ballot online, or else a third layer of security may be used, such as a secure database containing additional information. Once the voter has been authenticated, the voter may then vote online. The system can secure the vote and prevent others from attempting to vote using the same information and media storage device.

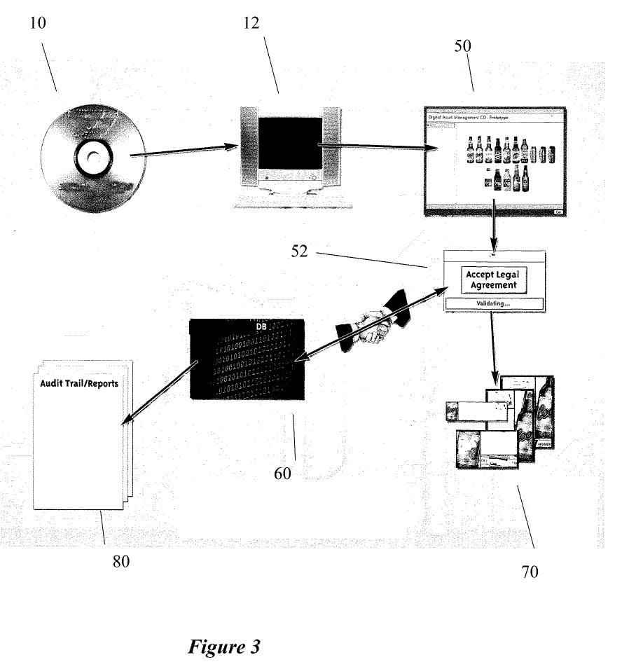

Another environment is for the management of digital rights. Digital rights to various types of intellectual property has become extremely important. These rights typically operate under licensing from the owners of the property. This property can range from data, music, video, images, literature and any other type of intellectual property. It has become increasingly popular to download this property online as desired. One particular application for the control of digital media rights is illustrated in FIG. 3. This application is similar to the above described system. The user inserts the physical media 10 in their computer 12. The physical media then launches the user to a particular website 50 that acts as portal to the digital media. The user then supplies their user identification and password. Additional information necessary to log onto the portal is then retrieved from the physical media.

This application further verifies the status of the user, that is, does the user have a current account to download media from the system, what media is the user allowed, credits to which the user may be entitled, payment information if necessary and other relevant information. Once the user has been authenticated, a screen is provided showing thumbnails or file information of digital media that the user is entitled to download. Once the user has made their selections, the system 60 then verifies that the selected media is still licensed for downloading. If the selected media is still properly licensed for downloading, the user is then directed to a licensing agreement for that digital media. Once the user has read and agreed to the licensing agreement, the user is then allowed to download files 70 that contain that digital media. The digital media may be promotional images for advertising and marketing, on-demand movies and videos for personal or business use, music clips, or any other type of digital media.

The system then provides an audit trail 80 so that the owner of the digital media may be compensated, as well as the other types of audit material described above. In one preferred embodiment, the downloaded media is provided with a unique serial number that is matched with the user to identify the source of unauthorized copying of the digital media. This unique serial number may be in the form of an encrypted file, a transparent watermark or any other type of identifying information.

Another application of the preferred embodiment of the present invention is for controlling unauthorized access to users, such as in the adult entertainment industry. The system prevents access unless the user has the physical media that contains the additional security information. Thus, as long as the adult maintains the physical media in a secure location, access by minors or others is prevented. The website operator may provide the physical media at locations where the true age and identity of the user is verified.

It is to be expressly understood that these and other embodiments of the present invention are within the scope of the present invention. The present invention is not limited to the above described embodiments.

Prevention of Unauthorized Copying

Another problem that is addressed by a preferred embodiment of the present invention is the problem of bootlegging or unauthorized copying of copyrighted or other materials. It is common to provide stock information replicated for mass distribution. Examples of this includes such items as music compact disks, movie DVDs, application software, data disks, promotional materials and many other items. One problem with such mass distributions is the inability to provide individual customization combined with mass distribution. Such information is typically replicated at high speeds, particularly in the case of compact disks and DVDs. While it may be possible to individually create each item of these mediums to provide customization, that would increase the cost of replication enormously and is not feasible.

One aspect of a preferred embodiment of the present invention is to allow custom personalization of stock information during the replication of digital information on physical media. A preferred embodiment of this invention utilizes systems and methods for inserting individual information during the replication of the physical media. For example, in one embodiment, the system utilizes an algorithm that inserts a unique alphanumeric sequence into the information during the replication process. This sequence is logged and can be retrieved if necessary to ascertain the actual physical media from which it came. This allows tracking of bootlegged media.

Another preferred embodiment of this present invention inserts information from a database that is merged into the stock information on the media as that media is being record, burned or otherwise replicated. This allows each media to be customized individually. For example, a database of customer information or account information may be merged into stock information as the media is being replicated.

Alternate Embodiment for Recognization Awards

Recognization awards have become a popular tool for rewarding and encouraging employees, customers, volunteers and other individuals and entities. These awards are often provided as incentives for increasing productivity, service, innovation, safety, community involvement, charity and many other desirable attributes. These awards often range from simple recognization, to rewards such as trips, watches, consumer goods, to financial rewards.

These recognization awards have taken on greater significance in recent years and have been an important part of employee and customer service departments of many companies. As these awards become more prevalent, the management of these awards, particularly in large companies, becomes more complex and expensive in terms of time, personnel and finances. This management includes the design of the award program, such as for productivity, longetivity, customer service or other attributes. Then the parameters of the program such as the goals and time frames have to be selected. The awards to be given for reaching those parameters have to be selected. The eligible individuals or entities for that program have to be selected. Those individuals or entities must be monitored to select those who have reached those parameters and notify the selected individuals or entities. The actual award must be presented either personally or by allowing the selected individuals or entities to select from a list. Then follow-up to ensure that those individuals or entities actually received their selected award. In larger companies this becomes an enormous burden on the human resources department.

The management of these awards is often given to outside fulfillment companies in many cases. The cost of providing a personal touch to such awards creates an expensive burden, particularly when there are large numbers of awards presented. Also, most companies prefer to offer a selection of awards to their recipients, as it is difficult to provide a personal award that is satisfactory to a large assortment of individuals or entities. This becomes an enormously complex task particularly for outside fulfillment companies who may be managing this process for different companies.

For example, these companies are presented with a list of eligible individuals which must be matched with the rewards that those eligible individuals may select from. Then those individuals are presented or notified of their receiving the award, preferably in the form of a semi-custom printed award. They are then provided either with a printed catalog or website access uniform resource locater code from which they can select their reward. Typically, the recipient must type in the code, along with a password, along with their shipping address and other information into the website. This often leads to mistakes and frustrations with the process. Often, the recipient will simply telephone their selection and information to the fulfillment company. This creates the need for telephone operators and tracking systems that increase the costs of these programs. Also, the opportunity for mistakes is greatly increased in this process which can diminish the pleasure and incentive in receiving these awards.

The present invention solves these and other problems by providing a system for providing a reward program that greatly reduces the required information input by the recipient while minimizing the requirement of intervention by third party support. It is to be expressly understood that while this system is discussed as implemented in an award recognization process, the present invention may also be implemented in other processes requiring the use of customization along with mass distributed materials and with processes requiring the use of personal information in a secure environment.

In a preferred embodiment of the present invention, the system includes a process for providing personalized information with stock or mass material. This system provides a personalized touch without the need to individually create each award. In this preferred embodiment, a set of rules are created that define the award program. The parameters of the program and the catalog of awards for each parameter are defined. A list of individuals or entities that are eligible for the program and who have reached a defined parameter are provided within a defined time period along with their related information. Then the award is created using a combination of stock material along with personalized information for each recipient. For example, individual information in a pre-arranged format such as the recipient's name, and their contribution (productivity, service, etc.) is combined with stock materials such as the company's history or reason for recognization, and information for selecting their award from the catalog of awards. Also, the individual information relating to the catalog of awards that the recipient may select from is included as well. This combined information is then provided in an award such as a printed certificate that may be presented to the recipient.

In the preferred embodiment of the present invention, this information is also recorded onto a compact disk, a DVD or digital media including but not limited to memory sticks, removable magnetic media or any other type of recordable media. The recorded information may include the award information but also includes information that is automatically sent to the on-line award catalog. For example, one embodiment of this feature would record the information regarding the catalog, the access code provided for the user to access the catalog and their eligibility for rewards from that catalog, shipping information and any other information that may be necessary for that recipient to select and receive their reward.

This embodiment may provide automatic connectivity to an internet website that would display through a browser. The user would simply insert the media into their computer or even through a kiosk and the media would through an auto run feature automatically connect to the appropriate website where the recipient could select their desired reward. This selection along with the necessary information regarding the recipient would automatically be transmitted to a server for processing. This eliminates the need for the recipient to take the information from their award, input that information into a computer to access the website catalog, select their reward, and input their personal information and shipping information. The possibility for mistakes during this data entry is eliminated.

The system of this preferred embodiment provides an automatic opaque connectivity that eliminates the need to provide access codes that could be intercepted and misused. The award recipient is provided a secure, easy to use process for claiming their reward. The system can be automated so that it can retrieve the eligibility list, apply that information in accordance with the defined rules, prepare the awards by combining the individual information with stock information, printing certificates, recording information on the media and transmitting the prepared award certificates and media to the recipient. The recipient simply inserts the media into a computer or kiosk and select their desired reward. The system then transmits that information to the host where the reward is picked and shipped to the recipient. The system can even prepare statements and reports to be transmitted to company for payment and quality control.

Another embodiment of the present invention is similar to the above described embodiment except rather than directing the recipient automatically to a website catalog, the website catalog is provided on the media itself. The media is inserted into a computer and a catalog of rewards is displayed on the computer monitor. The recipient selects their reward from this catalog. The selection and recipient information is then transmitted to the company, fulfillment company or other site. This transmission can be through an internet connection, or a company intranet network, or even through an automatic dial-up direct connection. Alternatively, the information can be printed and either sent by facsimile or mail or provided verbally over a telephone.

In another preferred embodiment, the system provides an additional feature to the above described embodiments. The media onto which the information is recorded includes a printed award certificate on the face of the media, such as a compact disk or DVD. The recipient is also provided with a clock kit. After the recipient has selected their reward, the media is removed from the computer. The clock kit is then assembled onto the media so that the printed award on the face of the media becomes a clock face. This provides further recognization of the recipient and their achievements.

It is to be expressly understood that these and other embodiments of the present invention are within the scope of the present invention. The present invention is not limited to the above described embodiments.

What is claimed is:

1. A method for authenticating the identity of a user over a network, the method comprising the steps of:
providing a user identification to a portal on the network;
providing a password associated with the user identification to the portal;
providing access to a physical medium having security information so that security information may be retrieved from said physical medium by the portal; and
authenticating the identity of the user from said user identification, said password and said security information from said physical medium.

2. The method of claim 1 wherein said step of providing access to said physical medium includes:
providing access to a removable storage media.

3. The method of claim 1 wherein said step of providing access to said physical medium having security information includes:
said security information being in an encrypted format.

4. The method of claim 1 wherein said step of providing access to said physical medium having security information includes:
said security information being an algorithm.

5. The method of claim 1 wherein said step of providing access to said physical medium having security information includes:
said security information being protected from copying from said physical medium.

6. The method of claim 1 wherein said method further includes:
providing access to information about the user stored on a secure server to further authenticate the identity of the user.

7. The method of claim 1 wherein said method further includes:
providing access to the user's financial account information.

8. The method of claim 1 wherein said method further includes:
providing access to licensed files for downloading.

9. The method of claim 1 wherein said method further includes:
providing access to age restricted websites.

10. The method of claim 1 wherein said method further includes:
verifying the status and access rights of the user.

11. The method of claim 1 wherein said method further includes:
verifying the payment information of the user.

12. The method of claim 1 wherein said method further includes:
verifying an executed user agreement with the user.

13. The method of claim 1 wherein said method further includes:
verifying the status and access rights of the user;
providing access to licensed media files to the user;
verifying that the licenses to said licensed media files are in effect; and
allowing the user to download selected licensed media files.

14. The method of claim 1 wherein said method further includes:
providing an audit trail of said user authentication and related transactions.

15. A system for authenticating the identity of user over a network, the system comprising:
a portal on the network for allowing entry of the user identification and password by the user;
removable physical media containing security information pertaining to authentication of the user's account; and
a verification mechanism for retrieving said security information from said removable physical media to authenticate the identity of the user in conjunction with said user identification and said password.

16. The system of claim 15 wherein said system further includes:
a secure server containing additional security information about the user; and
a second verification mechanism for retrieving said additional security information about the user from said secure server and verifying said additional security information with said security information from said removable physical media, said user identification and said password.

17. The system of claim 15 wherein said system further includes:
said security information on said physical media is protected from copying onto another physical media.

18. The system of claim 15 wherein said system further includes:
said security information on said physical media is encrypted.

19. The system of claim 15 wherein said system further includes:
said security information on said physical media is an algorithm.

20. The system of claim 15 wherein said system further includes:
said verification mechanism verifies the age of the user to restrict the user from age restricted websites if the user is underage.

21. The system of claim 15 wherein said system further includes:
a database of downloadable licensed media files; and
a license verification mechanism for verifying that licenses are valid for said licensed media files before allowing said licensed media files to be downloaded.

22. The system of claim 15 wherein said system further includes:
an auditing mechanism for providing an audit trail of the authentication process by the user and for any related transactions.
